(19) United States
(12) Patent Application Publication
(10) Pub. No.: US 2013/0100086 A1
(43) Pub. Date: Apr. 25, 2013

(54) ELECTRONIC APPARATUS USED AS STYLUS PEN

(71) Applicant: Hee-Young KIM, Seoul (KR)

(72) Inventor: Hee-Young KIM, Seoul (KR)

(73) Assignee: SAMSUNG ELECTRONICS CO., LTD., Gyeonggi-do (KR)

(21) Appl. No.: 13/596,443

(22) Filed: Aug. 28, 2012

(30) Foreign Application Priority Data
Oct. 21, 2011 (KR) 10-2011-0107985

(51) Int. Cl. G06F 3/033

(52) U.S. Cl. 345/179

(57) ABSTRACT

An electronic apparatus configured as a stylus pen is provided. The electronic apparatus includes a conductive stylus unit and an electric connection unit. The conductive stylus unit is detachably installed to one end of the electronic apparatus. The electric connection unit electrically connects power of the electronic apparatus to the stylus unit. When the stylus unit is mounted on the electronic apparatus, the power of the electronic apparatus is conducted to the stylus unit to operate a capacitive touch screen unit.

### CLAIM OF PRIORITY

This application claims the benefit under to a Korean patent application filed in the Korean Intellectual Property Office on Oct. 21, 2011 and assigned Ser. No. 10-2011-0107985, the disclosure of which is hereby incorporated by reference in its entirety.

### BACKGROUND OF THE INVENTION

1. Field of the Invention

The present invention relates to an electronic apparatus which may be used as a stylus pen.

2. Description of the Related Art

Recently, as various electronic and communication industries have developed, mobile terminal have become widely distributed. In addition the functional capability of mobile terminals has become more diversified to meet the needs and desires of users. Furthermore, mobile terminals have also become more miniaturized and lightweight with a slim profile.

In addition, may peripherals have been developed that are attached or added to the mobile terminal.. For example, these peripherals may include a camera apparatus and an auxiliary memory card attachable to or built in the mobile terminal, a microphone mounted on the mobile terminal to allow communication, or a Bluetooth headset, etc. for wireless communication via a Bluetooth module installed in the mobile terminal.

Mobile terminals having the Bluetooth function typically mount a separate Bluetooth antenna module for operating in a frequency band of 2.4 GHz therein apart from a primary antenna unit for communication, and a separate module for Bluetooth communication is mounted on a mainboard of the mobile terminal to perform short distance wireless communication with a Bluetooth headset.

The Bluetooth headset is used as a means of hands-free communication in using the mobile terminal. Since a separate cable with the mobile terminal is not required, the convenience of using the mobile terminal is increased, additionally the Bluetooth headset is conveniently carried compared with the general hands-free wired microphone/speaker unit.

Most recently mobile terminals capable of wireless communication with the Bluetooth headset have gradually been implemented as smart phones, and accordingly, a touch screen apparatus having a large-sized screen for simultaneous input/output functions have become ubiquitous in consideration of their ease of use, convenience and functionality.

Touch panels used for this touch screen apparatus are classified into various types of touch panels such as a resistive touch panel, a capacitive touch panel, an ultrasonic touch panel, a light (infrared) sensor type touch panel, an electro-magnetic induction type touch panel, and a sound wave touch panel, etc.

Recently, capacitive touch panel have becomes more prevalent. The capacitive touch panel detects a minute current flowing through a user's human body and reads a change in resistance to detect a touch at a relevant position on a touch panel.

A stylus pen, which is a separate touch tool, may be used for the capacitive touch panel. This stylus pen is constructed with its body portion, which a user grips, using conductive metal, the body portion is conductively attached to a portion of the stylus tip, so that a current flowing through a human body and is conducted to a touch panel.

Recently, a combination of a stylus and a Bluetooth headset shaped in a stick type and which provides a stylus pen means for touching a touch panel to the end of the headset have become available. This type of stylus and headset combination allows a user to touch the touch panel of a terminal using the stylus pen means and simultaneously to perform Bluetooth communication functions.

However, the Bluetooth headset used as a stylus pen to provide convenient function should include a housing with a headset body having metal to transfer a current of a human body to the stylus pen. However this causes a signal characteristic deterioration of the Bluetooth antenna radiator inside of the headset, and because the housing is limited to metal construction, an elegant appearance cannot be realized due to a limitation in design. In addition, since the headset body should be formed of metal, manufacturing costs increase.

### SUMMARY OF THE INVENTION

An aspect of the present invention is to address at least the above-mentioned problems and/or disadvantages and to provide at least the advantages described below. Accordingly, an aspect of the present invention is to provide an electronic apparatus used as a stylus pen configured to prevent performance deterioration of the apparatus.

Another aspect of the present invention is to provide an electronic apparatus used as a stylus pen designed configured to contribute to design improvement by not limiting the material for construction of the body that forms the housing of the electronic apparatus.

Still another aspect of the present invention is to provide an electronic apparatus used as a stylus pen configured to reduce manufacturing costs by excluding a housing body formed of metal and replacing the metal housing body with a housing body formed of a non-conductive material.

Yet another aspect of the present invention is to provide a Bluetooth headset used as a stylus pen configured to exclude a metal body housing in order to prevent signal performance deterioration of an internal Bluetooth antenna.

In accordance with an aspect of the present invention, an electronic apparatus used as a stylus pen is provided. The electronic apparatus includes a conductive stylus unit detachably installed to one end of the electronic apparatus, and an electric connection unit for electrically connecting to an internal power source of the electronic apparatus to the stylus unit, wherein when the stylus unit is mounted on the electronic apparatus, the internal power source of the electronic apparatus is conducted to the stylus unit to operate a capacitive touch screen unit.

The stylus unit includes a conductive rubber support including a connector electrically coupled to a charge and/or data transmission port of the electronic apparatus, and a conductive stylus rubber fixed in a way of completely enclosing the rubber support and having an end from which a tip for manipulating a touch screen extends.

The connector is electrically connected with a ground terminal of the charge and/or data transmission port to apply an electric current to the conductive rubber support.

The conductive rubber support includes a support body of a predetermined shape, a connector protruding from one end of the support body and electrically connected to the support body, and a tip support protrusion protruding from the other end of the support body and supporting the protruding tip of the stylus rubber.

When the rubber support is completely mounted on the stylus rubber, a predetermined space is formed between the tip support protrusion and an inner surface of the tip of the stylus rubber, allowing the tip to deform, so that the touch area provides an excellent touch sense by elasticity of a tip end.

A recess is formed along an outer peripheral surface in at least one portion of the rubber support, and a protrusion is formed in an inner peripheral surface of the stylus rubber, so that when the rubber support is completely mounted on the stylus rubber, the protrusion is seated in the recess, so that the rubber support is securely fixed inside the stylus rubber.

When mounted on the electronic apparatus, the stylus unit allows the stylus rubber to be fixed in a way of enclosing an end of the electronic apparatus, and simultaneously, allows the connector to be electrically coupled to the charge and/or data transmission port of the electronic apparatus.

A hook recess is formed in at least one of outer peripheral surfaces of the electronic apparatus, a hook protrusion is formed in an inner surface of the stylus rubber, so that when the stylus unit is completely mounted on the electronic apparatus, the hook protrusion of the stylus rubber is hooked at the hook recess of the electronic apparatus to prevent the stylus unit from arbitrarily being detached while a user manipulates or carries the stylus unit.

The electronic apparatus may be a stick type or pen type Bluetooth headset but is not limited thereto, and for example, may include various electronic apparatuses such as an MP3 player, a voice recorder, etc.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a perspective view illustrating a Bluetooth headset configured as a stylus pen with a mobile terminal according to an exemplary embodiment of the present invention;

FIG. 2 is an exploded perspective view illustrating a Bluetooth headset configured as a stylus pen of FIG. 1; and

FIG. 3 is a cross-sectional view illustrating in detail a portion of a Bluetooth headset configured as a stylus pen of FIG. 1.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

Though a stick type Bluetooth headset is exemplary described as an embodiment of an electronic apparatus in describing the present invention, the present invention is not limited thereto. For example, the present invention is applicable to other electronic apparatuses such as a stick type MP3 player including a charge or data communication port, and is applicable to electronic apparatuses of various shapes having an end to which a stylus unit is applicable though the electronic apparatus may not be a stick type.

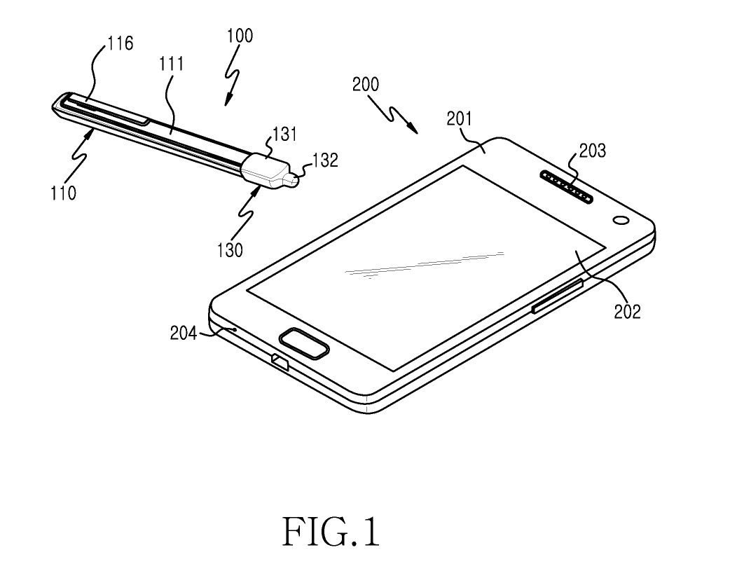

FIG. 1 is a perspective view illustrating that a Bluetooth headset configured as a stylus pen used with a mobile terminal according to an exemplary embodiment of the present invention.

Referring to FIG. 1, the mobile terminal 200 includes a touch screen unit 202 installed on a front side 201 of the mobile terminal 200. The mobile terminal 200 also includes a speaker unit 203 and a microphone unit 204 installed on a predetermined location of the mobile terminal 200.

A Bluetooth headset used as a stylus pen 100 is a stick type or a pen type, and includes a Bluetooth headset 110 having a predetermined length and a stylus unit S detachably installed to the end of the Bluetooth headset.

In the Bluetooth headset 110, a Printed Circuit Board (PCB) is installed inside a headset body 111, and various electronic parts (electronic function group) such as a Bluetooth antenna radiator (not shown), etc. are mounted on the PCB. Also, a pocket clip 116 that can be inserted into a user's pocket is installed on the outer surface of the headset body 111.

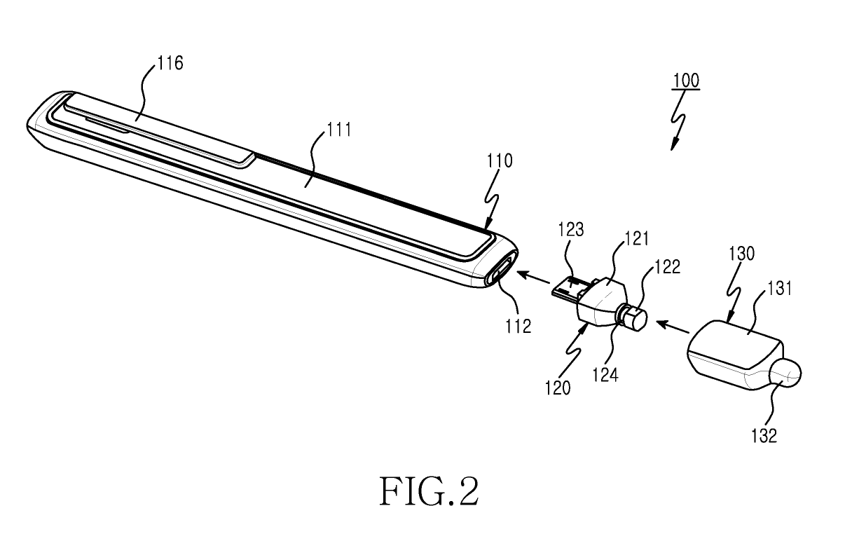

The stylus unit S is formed of a conductive rubber material and includes a stylus rubber 130 and a tip 132 protruding and extending from the end of the stylus rubber 130. Therefore, the stylus rubber 130 may be mounted in a way of partially enclosing the headset body 111 of the Bluetooth headset 110. The stylus rubber may be fixed with a connector 123 (of FIG. 2) and a rubber support 120 (of FIG. 2), which will be described later, supporting the stylus rubber 130 within a charge port 112 formed in the end of the headset body 111. More detailed construction is described later.

Meanwhile, as illustrated in FIG. 1, according to the present invention, unlike the conventional art, the headset body 111 of the Bluetooth headset 110 may be formed of non-conductive material. Preferably, the headset body 111 may be formed of a synthetic resin using injection molding to provide an elegant appearance and various shapes. This is possible because the stylus unit S is formed of a conductive material and electrically connected with a conductive means inside the Bluetooth headset 110, so that a user may manipulate the capacitive touch panel with the above-described stylus unit.

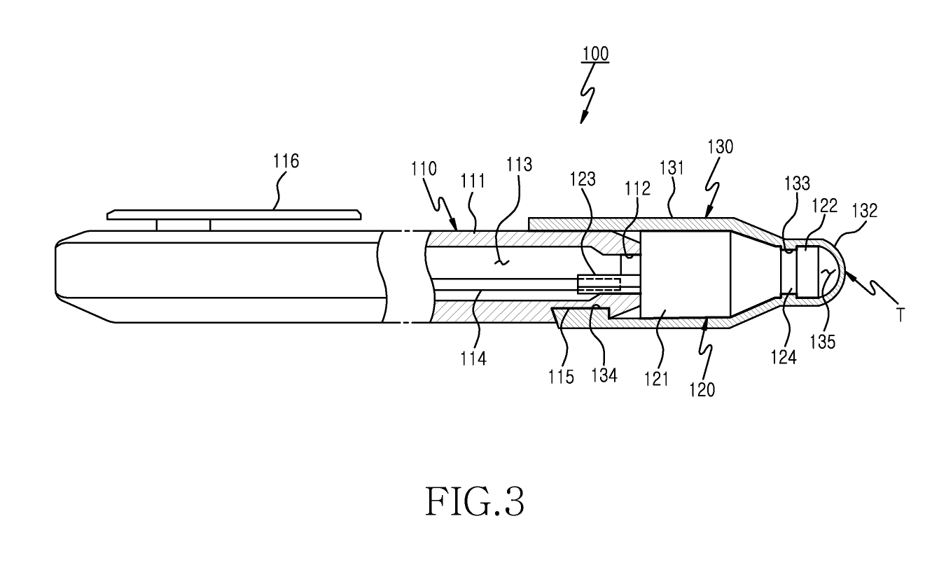

FIG. 2 is an exploded perspective view illustrating a Bluetooth headset used as a stylus pen 100 of FIG. 1, and FIG. 3 is a cross-sectional view illustrating in detail a portion of a Bluetooth headset used as a stylus pen 100 of FIG. 1.

Referring to FIGS. 2 and 3, the Bluetooth headset configured as a stylus pen 100 includes a Bluetooth headset 110 and the stylus unit S detachably installed to one end of the Bluetooth headset 110.

The Bluetooth headset 110 includes the headset body 111 having a predetermined length and an inner space for mounting and containing electronic circuitry and components. A PCB 114 is installed in an inner space 113 of the headset body 111, and a plurality of electronic component parts (electronic function group) including a Bluetooth antenna radiator (generally, a chip antenna radiator) (not shown) are mounted on the PCB 114. A pocket clip 116 protrudes on the outer surface of the headset body 111, so that a user may insert and retain the Bluetooth headset within the user's pocket. In addition, a charge port 112 is installed to one end of the headset body 111 to receive power for driving the Bluetooth headset 110.

The stylus unit S includes the rubber support 120 having a predetermined shape and the stylus rubber 130 installed to enclose the rubber support 120. The rubber support 120 and the stylus rubber 130 are formed of a conductive material. The rubber support 120 may be formed of a conductive synthetic resin, and the stylus rubber 130 may be a conductive rubber.

The rubber support 120 includes a rectangular support body 121, a connector 123 protruding from one end of the support body 121 and mountable on the charge port 112 of the Bluetooth headset 110, and a tip support protrusion 122 formed with a reduced size on the other end of the support body 121.

The stylus rubber 130 includes a rubber body 131 having an inner space for completely enclosing the rubber support 120, and a tip 132 protruding and extending from one end of the rubber body 131. The tip 132 has an end T formed in a curved shape to allow a user to accurately touch a desired position on the capacitive touch panel. Therefore, when the rubber support 120 is fit in the stylus rubber 130 tightly, the stylus unit S is completed. A protrusion 133 is formed along an inner peripheral surface in the inner side of a portion where the tip 132 of the stylus rubber 130 starts, and a recess 124 is formed in a portion where the tip support protrusion 122 of the rubber support 120 starts. Therefore, when the rubber support 120 is mounted within the stylus rubber 130, the protrusion 133 of the stylus rubber 130 is received and retained by the recess 124 of the tip support protrusion 122 firmly and seated, so that the rubber support 120 is fixed in the stylus rubber 130 more solidly. Therefore, only the stylus rubber 130 will be seen as the stylus unit S in the outside.

Furthermore, a space 135 is generated in the inside of the tip 122 even when the rubber support 120 is completely mounted in the stylus rubber 130, so that when a user touches the capacitive touch panel, the tip 132 may deform slightly and thus a wider touch area is generated to induce an accurate touch position detection and provide a smooth touch sense to the user.

When mounting the stylus unit S on the Bluetooth headset 110, the user couples the stylus rubber 130 to an end of the headset body 111 of the Bluetooth headset 110. At this point, the stylus rubber 130 is coupled in a way of enclosing the end of the headset body 111. Simultaneously, the connector 123 protruding from the rubber support 120 is mounted in the charge port 112 of the Bluetooth headset 110. At this point, the connector 123 is supplied with power from the charge port 112. Preferably, the connector 123 may be connected with a ground terminal (not shown) of the charge port 112. However, the connector 123 is not limited thereto but may use a separate power supply unit provided to the Bluetooth headset 110.

Meanwhile, when the user connects the stylus unit S to the Bluetooth headset 110, a hook protrusion 134 protruding from the inside of the stylus rubber 130 is hooked at the hook recess 115 formed on the outer surface of the headset body 111 of the Bluetooth headset 110, so that the stylus unit S may be more securely mounted on headset body 111..

Therefore, when the stylus unit S is connected to the Bluetooth headset 110, power applied from the charge port 112 of the Bluetooth headset 110 is applied through the connector 123, to the rubber support 120, the rubber body 131, and the tip 132, so that an electrical current may flow through the Bluetooth headset.

Consequently, even when the headset body 111 is formed of a non-conductive material (for example, a synthetic resin, etc.) which is relatively less limited in design unlike the conventional art that forms the headset body 111 of the Bluetooth headset 110 with metal and a current of a human body, the user may conveniently and swiftly manipulate a capacitive touch panel using the Bluetooth headset configured as the stylus pen according to the present invention.

Table 1 represents sensitivity comparison for the conventional stylus pen and a capacitive touch panel using a Bluetooth headset used as a stylus pen according to the present invention.

TABLE 1

| Recognition load | Conventional art | Present invention |
|---|---|---|
| 35 gf | Sensitivity 52~57 | Sensitivity 52~57 |
| 50 gf | Sensitivity 60 or more | Sensitivity 52~57 |

Notes
similar recognition rate when compared with a conventional stylus pen
recognition rate is OK if sensitivity 45 or more

Table 1 has been obtained by experiments performed using a melfas MCS6024 touch IC. Since a touch signal has been set using 1 byte as a reference, sensitivity has been numerically expressed by setting a step of a rate of change in sensitivity from 0 to 255. In this case, compared to the conventional art, the present invention has secured a sensitivity score of 45 or more, which is a general touch recognition sensitivity, which means that manipulation is swiftly performed.

Since the electronic apparatus used as a stylus pen according to the present invention forms a body forming a housing of the apparatus with a non-conductive material, performance deterioration of an inner unit (for example, performance deterioration of the Bluetooth antenna radiator of the Bluetooth headset) is prevented.

In addition, the present invention has no limitation in the material of the body of the electronic apparatus with respect to design, and also reduces manufacturing costs by excluding a metal housing body and replacing the metal housing body with the housing body formed of a synthetic resin.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An electronic apparatus configured as a stylus pen, the electronic apparatus comprising:
a conductive stylus unit detachably installed to one end of the electronic apparatus; and
an electric connection unit for transferring electrical power from the electronic apparatus to the stylus unit,
wherein when the conductive stylus unit is mounted on the electronic apparatus, the power of the electronic apparatus is conducted to the stylus unit to operate a capacitive touch screen unit.

2. The electronic apparatus of claim 1, wherein the conductive stylus unit comprises;
a conductive rubber support comprising a connector electrically coupled to a charge and/or data transmission port of the electronic apparatus; and
a conductive stylus rubber mounted on the conductive rubber support and having an end from which a tip for manipulating a touch screen protrudes.

3. The electronic apparatus of claim 2, wherein the connector is electrically connected with a predetermined terminal of the charge and/or data transmission port to apply an electric current through the conductive rubber support to the conductive stylus unit.

4. The electronic apparatus of claim 2, wherein the conductive rubber support comprises:
a support body of a predetermined shape; and
a tip support protrusion extending from one end of the support body for receiving and supporting the tip of the conductive stylus rubber,
wherein the connector protrudes from the other end of the support body and electrically is connected to the support body.

5. The electronic apparatus of claim 4, wherein a predetermined space is provided between the tip support protrusion and an inner surface of the tip of the conductive stylus rubber when the conductive rubber support is mounted thereon.

6. The electronic apparatus of claim 4, further comprising a a protrusion along an inner peripheral surface of the conductive stylus rubber, and a recess along an outer peripheral surface of the conductive rubber support adapted to receive the protrusion such that, when the conductive rubber support is mounted on the conductive stylus rubber, the protrusion is seated in the recess.

7. The electronic apparatus of claim 2, wherein the conductive stylus rubber encloses the one end of the electronic apparatus when the connector is electrically coupled to the charge and/or data transmission port of the electronic apparatus.

8. The electronic apparatus of claim 7, further comprising a hook protrusion located on an inner surface of the conductive stylus rubber, and a hook recess in at least one of outer peripheral surfaces of the electronic apparatus adapted to receive the hook protrusion for securely retaining the conductive stylus unit. ,

9. The electronic apparatus of claim 1, wherein the electronic apparatus comprises a Bluetooth enabled headset.

10. The electronic apparatus of claim 1, wherein the electronic apparatus has an exterior body that is made of a non-conductive material.

11. The electronic apparatus of claim 10 wherein the non-conductive material is a synthetic resin.

12. A stylus unit used as a stylus pen coupling an electronic apparatus, the stylus unit comprising:
a conductive rubber support comprising a connector electrically coupled to a charge and/or data transmission port of the electronic apparatus; and
a conductive stylus rubber mounted on the conductive rubber support and having an end from which a tip for manipulating a touch screen protrudes,
wherein when the stylus unit is mounted on the electronic apparatus, the power of the electronic apparatus is conducted to the stylus unit to operate a capacitive touch screen unit.

13. The stylus unit of claim 12, wherein the connector is electrically connected with a predetermined terminal of the charge and/or data transmission port to apply an electric current through the conductive rubber support to the stylus unit.

14. The stylus unit of claim 12, wherein the conductive rubber support comprises:
a support body of a predetermined shape; and
a tip support protrusion extending from one end of the support body for receiving and supporting the tip of the conductive stylus rubber,
wherein the connector protrudes from the other end of the support body and electrically is connected to the support body.

15. The stylus unit of claim 12, wherein the conductive stylus rubber encloses the one end of the electronic apparatus when the connector is electrically coupled to the charge and/or data transmission port of the electronic apparatus.

16. The stylus unit of claim 12 wherein the non-conductive material is a synthetic resin.

17. An input method for use with a capacitive touch screen terminal, the input method comprising:
providing a conductive stylus unit having a hollow interior cavity,
attaching an electric connection unit to the conductive stylus unit,
installing an electronic apparatus contained within the hollow interior cavity of the conductive stylus unit, wherein the electronic connection unit transfers electrical power from the electronic apparatus to the conductive stylus unit, and
contacting the conductive stylus unit to the capacitive touch screen.

18. The input method of claim 17, wherein contacting the conductive stylus unit further includes manipulating the touch screen surface with the conductive stylus unit.

19. The input method of claim 17, wherein the conductive stylus unit comprises;
a conductive rubber support comprising a connector electrically coupled to a charge and/or data transmission port of the electronic apparatus; and
a conductive stylus rubber mounted on the conductive rubber support and having an end from which a tip for manipulating a touch screen protrudes.

20. The input method of claim 19, wherein the conductive rubber support comprises:
a support body of a predetermined shape; and
a tip support protrusion extending from one end of the support body for receiving and supporting the tip of the conductive stylus rubber,
wherein the connector protrudes from the other end of the support body and electrically is connected to the support body.
